(19) United States
(12) Patent Application Publication
(10) Pub. No.: US 2010/0049727 A1
(43) Pub. Date: Feb. 25, 2010

(54) COMPRESSING XML DOCUMENTS USING STATISTICAL TREES GENERATED FROM THOSE DOCUMENTS

(75) Inventors: Umesh Kumar Balegar, Bangalore (IN); Rohit Shetty, Bangalore (IN)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/194,599

(22) Filed: Aug. 20, 2008

(51) Int. Cl. G06F 7/00; G06F 17/30

(52) U.S. Cl. 707/101; 707/E17.006

(57) ABSTRACT

Compressing data from a markup language document such as an XML document includes the steps of creating from the document a path based statistical tree built according to a given set of rules, and compressing the document by using the statistical tree. In an embodiment, the statistical tree includes a multitude of paths, and a single bit represents each of said paths. Also, the document may include both enumerated data and non-enumerated data, and the enumerated data is compressed by using the statistical tree. In an embodiment, the document includes a multitude of document nodes, and the step of creating the path based statistical tree includes the step of forming said tree with a multitude of tree nodes, each of the tree nodes representing one of the document nodes.

### BACKGROUND OF THE INVENTION

XML (eXtensible Markup Language) is a standard for creating markup languages, which allow the description of different types of data and simplify sharing of structured information. XML is used as a standard for documents sent over the Internet and in other multimedia fields.

XML documents tend to be quite large compared to other forms of data representation and this has been a cause for concern among people who want to use XML for data representation. Some existing techniques use restructuring the document and then running regular text compression, i.e., gzip on this. This provides compression.

### SUMMARY OF THE INVENTION

Embodiments of the invention compressing data from a markup language document such as an XML document. An embodiment of a method includes creating from the document a path based statistical tree built according to a given set of rules, and compressing the document by using the statistical tree. In an embodiment, the statistical tree includes a multitude of paths, and a single bit represents each of said paths. Also, the document may include both enumerated data and non-enumerated data, and the enumerated data is compressed by using the statistical tree. In this embodiment, the path based statistical tree is formed with a multitude of tree nodes, each of which representing node one of the document nodes. More specifically, identifying a root node of the document and starting the tree with a node denoting that root node of the document start the tree.

An embodiment of the invention, described in detail below, is based on the principal of using the XML Document directly to create a path based tree built on a certain set of rules and using this tree to encode the XML body and the enumerated data in the XML document. A distinguishing feature of this tree is that each path is represented by a single bit, i.e., 0 or 1 which helps to represent the whole XML document structure in as little as a few bytes of data. The only data that is not considered in this compression is the data that is defined by the user, i.e., non-enumerated data that can be compressed using the normal text-based compression techniques.

An important aspect of this approach is that the compression of the structure is independent of the compression used for the data and the compression achieved is very high. If the XML document contains only enumerated data, then a separate compression process for the data will not be required since this compression will take care of this completely. This technique also makes querying for data in the partially compressed XML document easier.

In the basic architecture of an embodiment of the invention, the XML document which needs to be compressed is passed to a Statistical Tree Generator which processes the XML document and builds the Statistical Trees from the information read from the XML document. A structural compressor uses this tree to compress the XML records retrieved by a parser and produces the compressed structure and enumerated data along with the uncompressed data, which can be used as an input to the next level of compression or can be stored directly.

An approach for statistical XML structural compression involves four parts: Statistical tree generation directly from XML Document; Optimizing the generated tree so that the elements maximum occurrence in the XML document would get the least bit trace; Encoding the XML Document using the Statistical Trees generated; and Decoding the Encoded XML Document using the same Statistical Trees generated during Encoding.

### BRIEF DESCRIPTION OF THE DRAWINGS

FIG. 1 shows the basic architecture of an XML compression system according to an embodiment.

FIG. 2 gives a sample XML document according to an embodiment.

FIG. 3 shows node branching that can occur as a statistical tree is built from the XML document of FIG. 2 according to an embodiment.

FIG. 4 illustrates a genuine node of the statistical tree according to an embodiment.

FIG. 5 shows a root node of the statistical tree according to an embodiment.

FIG. 6 illustrates the building of a statistical tree for the root node of FIG. 5 according to an embodiment.

FIG. 7 shows a node data representation in the statistical tree according to an embodiment.

FIG. 8 shows the statistical tree of FIG. 6 modified to include node data according to an embodiment.

FIG. 9 shows the complete statistical tree for a specified node before optimization according to an embodiment.

FIG. 10 shows a node statistical tree built from one of the nodes of the tree of FIG. 9 according to an embodiment.

FIG. 11 shows the statistical tree partially optimized after applying a first optimization rule according to an embodiment.

FIG. 12 shows the statistical tree further optimized after applying a second optimization rule according to an embodiment.

FIG. 13 illustrates a flowchart of a method of building the statistical tree from the XML document according to an embodiment.

FIG. 14 shows a flowchart of a method for optimizing the statistical tree according to an embodiment.

FIG. 15 is a block diagram of a computing environment in which embodiments may be implemented.

### DETAILED DESCRIPTION

The eXtensible Markup Language (XML) is a standard for creating markup languages. Languages based on XML can describe different types of data in addition to text data and can simplify sharing of structured information on, for example, the Internet. A program without knowledge of the language itself may process documents written in an XML-based language. XML and other data description languages allow software developers to specify fundamental language syntax by defining a document type definition (DTD) that specifies constraints on the document structure. A typical DTD employed for interpretation of an XML document specifies allowable XML elements, attributes, and allowable attribute values. Alternatively, an XML schema may be defined.

An XML file is a text file, which must conform to various XML syntax rules. Particularly, an XML document must include a declaration that declares an identifier, which specifies the document as an XML-compliant file. A declaration can be considered as a definition. Identifiers may be declared. In XML, several things are said to be declared, e.g., namespaces, data types, and version. For example, the XML declaration may identify an XML version and may specify a character-encoding format. XML encoding generally defaults to 8-bit Unicode Transformation Format (UTF-8), using the following declaration:

<?xml version=“1.0” encoding=“UTF-8” ?>.

In XML terms, this is technically a so-called “processing instruction,” that in effect says, “This is an XML document that conforms to XML specification version 1.0 and is encoded in a character set called UTF-8.”

An XML-compliant document comprises a single root element, and elements containing data entries must be delineated with both a start tag, e.g., “<element_a>”, and an end tag, e.g., “</element_a>”. Additionally, attribute values are delineated with quotations, and nested (but not overlapping) tags are permissible.

This disclosure describes compressing data from a markup language document such as an XML document. According to an embodiment, a method comprises creating from the document a path based statistical tree built according to a given set of rules, and compressing the document by using the statistical tree.

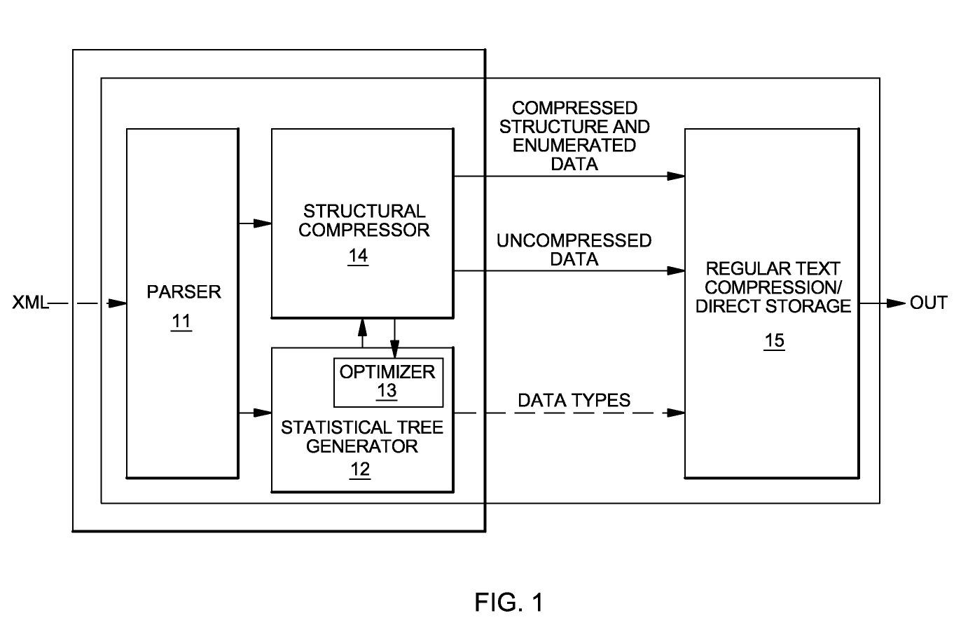

FIG. 1 shows the basic architecture of a system using the statistical structural compressor procedure according to an embodiment. Here, the XML document that needs to be compressed is passed via Parser 11 to a Statistical Tree Generator 12, which processes the XML document and builds the Statistical Trees from the information read from the XML document. An optimizer 13 is used to optimize the Statistical Tree, and a structural compressor 14 uses this tree to compress the XML records retrieved by the parser. Compressor 14 produces the compressed structure and enumerated data along with the uncompressed data, which can be used as an input to the next level of compression 15 or can be stored directly.

The approach for statistical XML structural compression involves four parts: Statistical tree generation directly from XML Document; Optimizing the generated tree so that the elements maximum occurrence in the XML document would get the least bit trace; Encoding the XML Document using the Statistical Trees generated; and Decoding the Encoded XML Document using the same Statistical Trees generated during Encoding. Each of these parts is discussed below in detail.

### Statistical Tree Generation

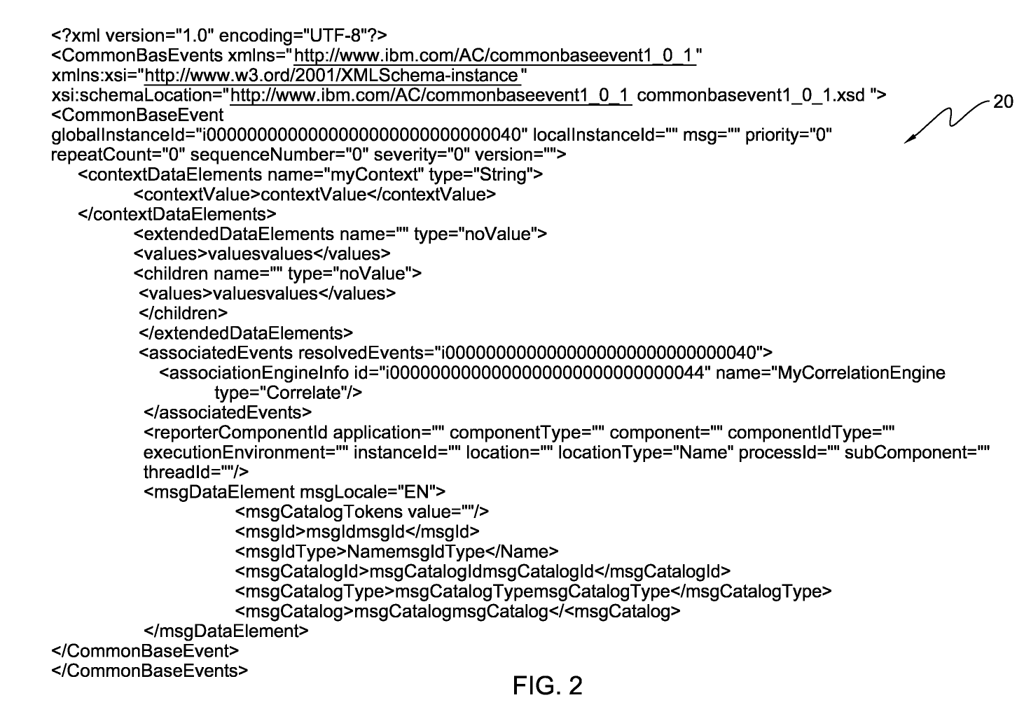

This involves generating a statistical tree using the information available in the XML document. The information available in the XML can be represented in the form of a tree. This tree will describe the paths in the XML document using a single bit, i.e. 0 or 1, and will help represent the whole XML structure using a few bytes by defining the paths to each of the elements etc. The process of building the tree will be described below using the sample XML given in FIG. 2.

FIG. 2 is a text display illustrating a traditional XML document according to an embodiment. XML document 20 comprises a declaration, which defines the XML version and character encoding. XML document 20 further comprises a root element delineated with a root element start tag and a root element end tag. Any elements between the root element start tag and root element end tag are referred to as child elements. Child elements include element content XML elements may comprise attributes that provide additional information about the XML document root element and child elements. Name/value pairs, where the value is placed between opening and closing quotations and is located in an element start tag, define attributes.

A statistical tree can be generated from the XML document if the document satisfies basic XML properties like the XML under use should be a well-formed XML document.

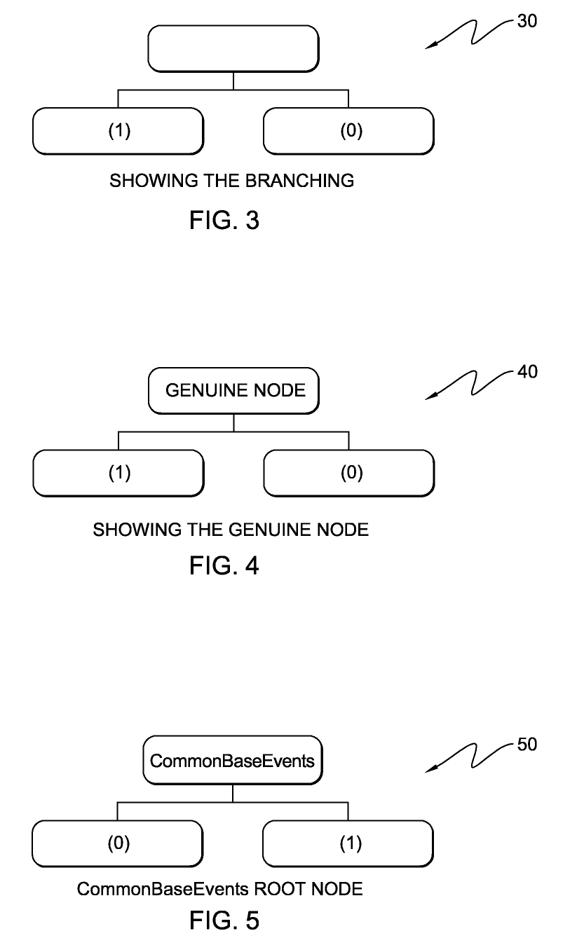

Every parent node which is an element may have at least one child node that is a leaf node, and whenever there are multiple children that needs to be accommodated into a particular node, that node will be branched using the sub-tree shown at 30 in FIG. 3. Further, in the discussion below, any node that denotes a XML element, tag or attribute is addressed as a “genuine” node, represented at 40 in FIG. 4.

Every node in the XML tree has a few intrinsic characteristic properties (e.g., Namespace definition, Namespace adherence, etc.), which may be tagged with the Node, so that these characteristic properties can be carried along with the node.

Further, such trees are built for each Genuine Node, which has child nodes other than the Leaf Node, and these individual Statistical Trees are referred to as “Node Statistical Trees”. These Node trees will be uniquely identifiable using their names just as in the case of normal XML Dom Structure. Further, any tag/element/attribute that has a reference to some other tag/element/attribute is considered to be of the same type as its reference, and its properties will be a union of its and its reference's properties.

Every XML document would start with a “Root Node”, so the first Genuine Node encountered will be the Root Node. In the XML Snippet shown in FIG. 2, the first Genuine Node encountered is “CommonBaseEvents” Root Node. This is represented at 50 as a part of Statistical Tree as shown in FIG. 5.

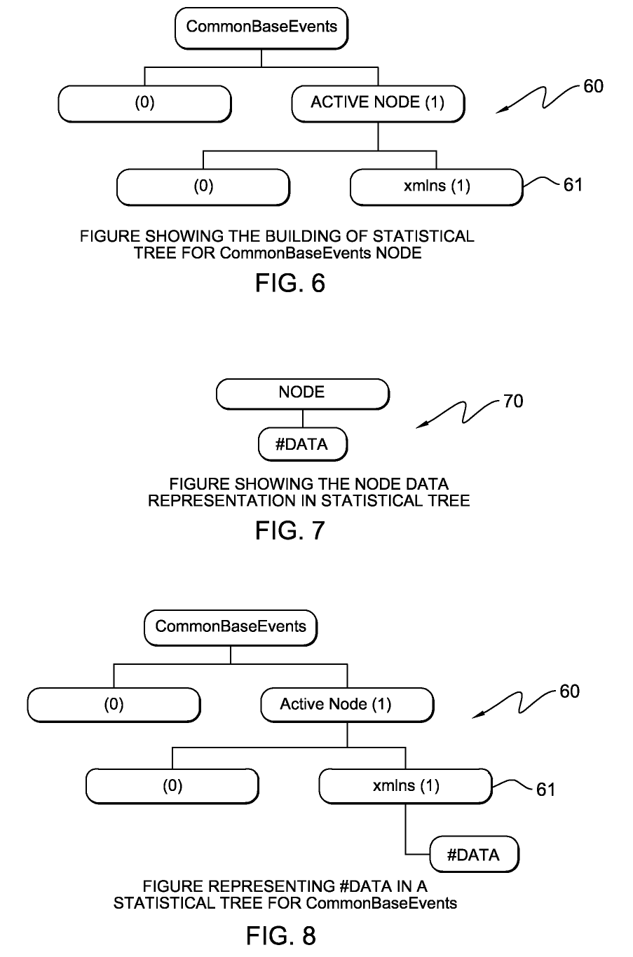

The CommonBaseEvents node has three attributes and one child element. As this Node contains children other than the Leaf nodes, a placeholder needs to be provided for the children under the Parent CommonBaseEvent. This is done by splitting the node identified by (1) under CommonBaseEvents genuine node as shown at 60 in FIG. 6. As can be seen from the XML snippet, the first attribute is “xmlns”, and this is added to the (1) Leaf Node as shown at 61 in FIG. 6.

When generating the statistical tree, it may be useful to represent data that would generally be present in the XML document. When traversing the statistical trees, data will need to be retrieved from the data source. This may be represented in the Node Statistical Tree as shown at 70 in FIG. 7. Each time a node is reached with the ‘#data’ leaf node, non-enumerated data is to be retrieved from data storage.

On modifying the figure for CommonBaseEvents, the statistical tree shown in FIG. 8 is obtained.

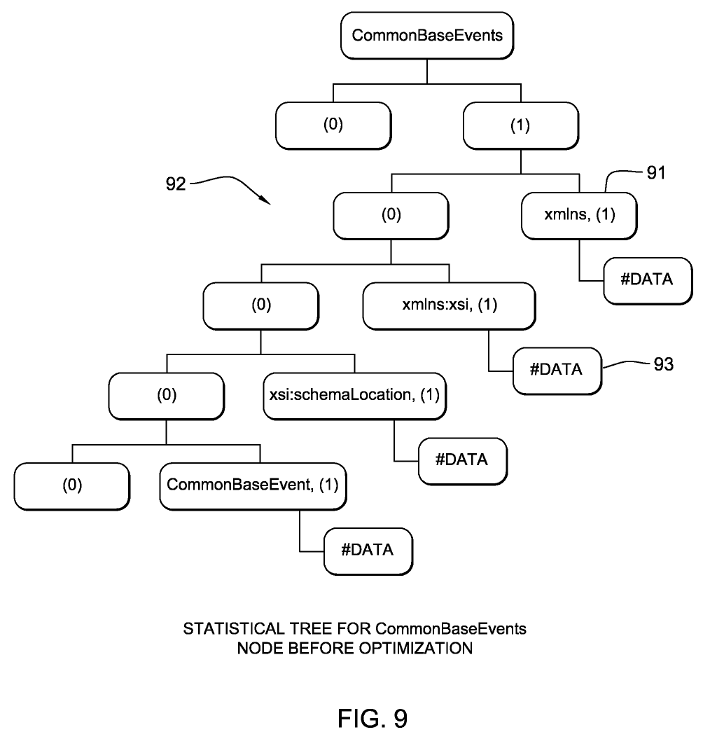

As the xmlns has only text data associated with it, this is considered as one of the leaf nodes of the CommonBaseEvents node, so the data is picked up and sent for data processing, and the node information of (1) is updated with attribute xmlns properties, as shown at 91 in FIG. 9. Once this is done, the node (0) is set active. Next in the attribute list is the xmlns:xsi. To add this to the Statistical tree, the current active node (0) is split into two branches (0) and (1), as shown at 92 in FIG. 9. As even this attribute just contains text data, the node is added at 93 to the Statistical tree and the data is sent for Data Processing. This procedure repeats until the attributes and child elements are processed. If any of the children has child elements associated with it, then a separate tree is built for that element.

In the above Statistical Tree for CommonBaseEvents, CommonBaseEvent is a child element, which has one or more children. So, as shown in FIG. 9, a new Node Statistical Tree is built with the root node being “CommonBaseEvent”. The rest of the other nodes in the tree, like xmlns, xmlns:xsi, xsi:schemaLocation, do not have any children associated with them as they are identified as the leaf nodes of CommonBaseEvents tag. So, a separate Node Statistical Tree is not built for these nodes.

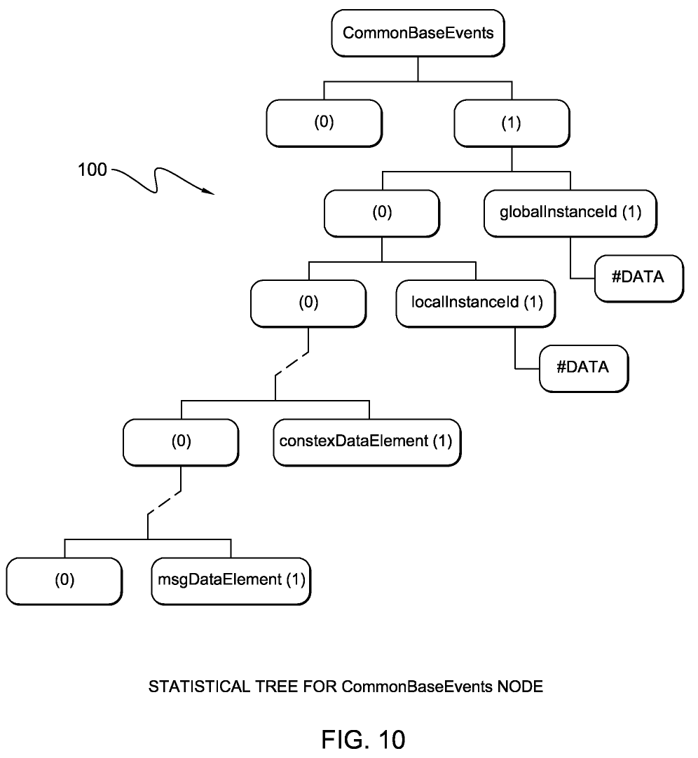

FIG. 10 shows the Node Statistical Tree 100 for CommonBaseEvent. At the time of encoding, the required Node Statistical Trees would be combined to generate the encoding bits. It may be noted that the dotted lines in FIG. 10 indicate the nodes are not shown in the Statistical Tree.

### Optimization of the Statistical Trees Built

An “Element Counter” is initialized when a node is first added to the Statistical Tree. The purpose of this counter is to keep track of the number of times the same node appears in the XML Document being processed. Every time a node is identified, a look up is done in the already built Statistical Trees to check if this node has already appeared and has been included in the Statistical Tree of its Parent node. If yes, then the Element counter of the node identified is incremented by 1.

Once the Statistical trees are built, Optimization of the Statistical trees is done. Optimization of the Statistical Tree involves rearranging of the nodes in each Statistical tree based on the value in individual “Element Counter”.

The nodes in a Statistical Tree may be arranged in a decreasing order of the value in individual Element counter, i.e., the node with highest Element counter value would come to the top of the tree and the node with the least Element counter value would go to the bottom of the tree. This Optimization step may ensure that the nodes that occur more times in an XML Document would get the least bit trace in the tree. If the Element counter for two or more nodes is same, then the nodes that have same Element counter value are, for example, rearranged in their alphabetical order.

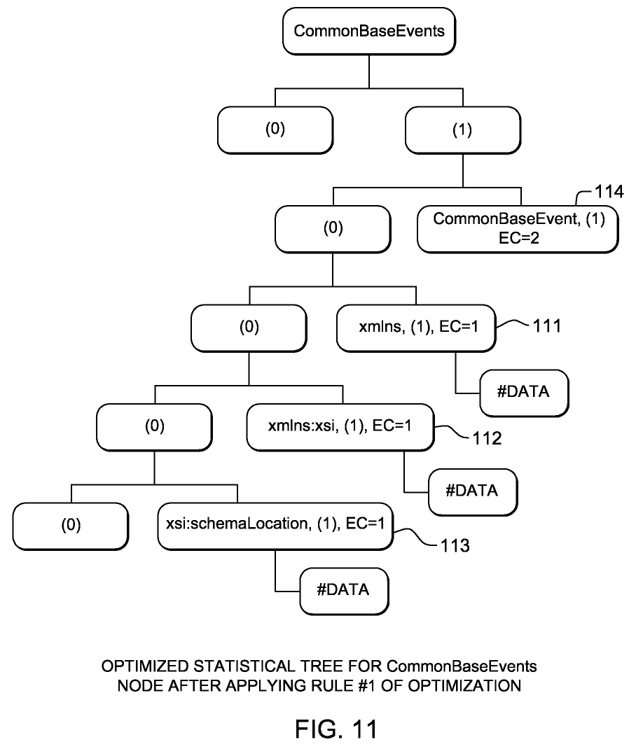

FIG. 11 shows an Optimized Statistical tree for CommonBaseEvents node. In this example:
Element counter=1 for xmlns node 111,
Element counter=1 for xmlns:xsi node 112,
Element counter=1 for xsi:schemaLocation node 113, and
Element counter=2 for CommonBaseEvent node 114.

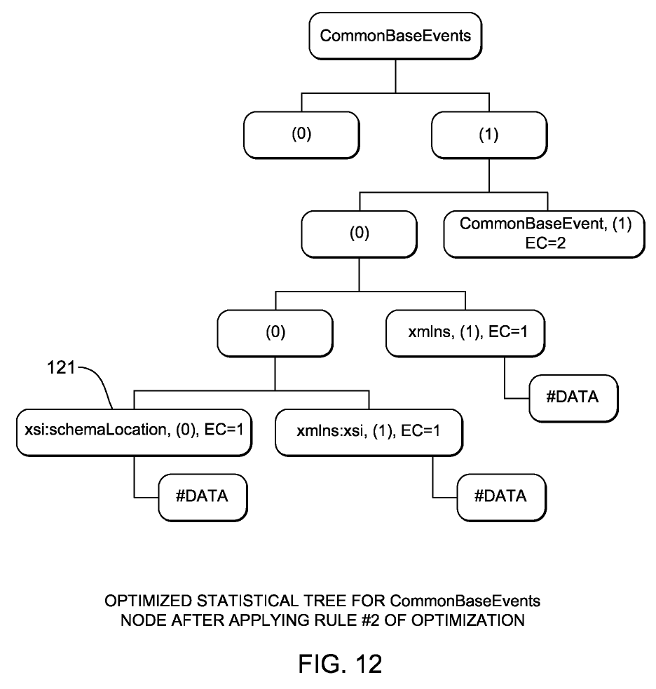

After the Statistical Tree is optimized based on the counts for each node in the tree, for every Statistical Tree formed, then nodes denoted by the active node and its peer is collapsed with its parent, so that the peer child is directly the child of its parent node, i.e., for the last node xsi:schemaLocation and the active node represented by (0) are considered to be the peer nodes in observation. These two branches from the node denoted by (0) which is a peer of xmlns:xsi. Now as the peer (0) node of xmlns:xsi is represented by two nodes, these two nodes can be merged into a single node representing xsi:schemaLocation as a peer to xmlns:xsi instead of node (0). This is depicted at 121 in FIG. 12.

Building the Statistical Tree from the XML Document

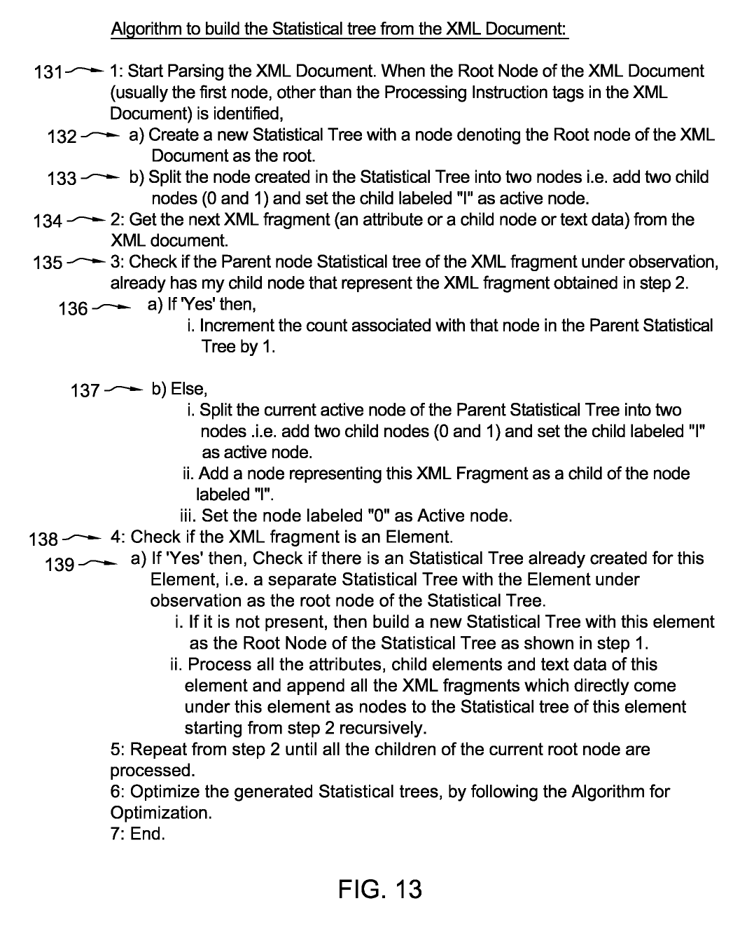

FIG. 13 is a flowchart illustrating a method for building the Statistical Tree from the XML document according to one embodiment. Step 131 is to start parsing the XML Document. When the Root Node of the XML Document (usually the first node, other than the Processing Instruction tags in the XML Document) is identified, then, at step 132, a new Statistical Tree is created with a node denoting the Root node of the XML Document as the root and at step 133, the node created in the Statistical Tree is split into two nodes, i.e., add two child nodes (0 and 1) and set the child labeled “1” as active node. Step 134 is to get the next XML fragment (an attribute or a child node or text data) from the XML document

Step 135 is to check if the Parent node Statistical tree of the XML fragment under observation already has any child node that represents the XML fragment obtained in step 134. If so, then, at step 136, the count associated with that node in the Parent Statistical Tree is incremented by 1. However, if at step 135, the Parent node Statistical Tree does not have a child node that represents the XML fragment, then, at step 137, the current active node of the Parent Statistical Tree is split into two nodes, i.e., add two child nodes (0 and 1) and set the child labeled “1” as active node. Also, at step 137, a node is added representing this XML Fragment as a child of the node labeled “1”, and the node labeled “0” as is set as an Active node.

Step 135 is to check if the XML fragment is an Element. If it is, then step 139 is to check if there is a Statistical Tree already created for this Element, i.e., a separate Statistical Tree with the Element under observation as the root node of the Statistical Tree. If it is not present, then a new Statistical Tree is built with this element as the Root Node of the Statistical Tree, as shown in step 131. The attributes, child elements and text data of this element are processed and the XML fragments, which directly come under this element, are appended as nodes to the Statistical tree of this element starting from step 134 recursively.

Steps 134-139 are repeated until the children of the current root node are processed. When this is done, the following the Method for Optimization discussed below optimizes the generated Statistical Trees.

### Optimizing the Statistical Trees Built Using the Above Method:

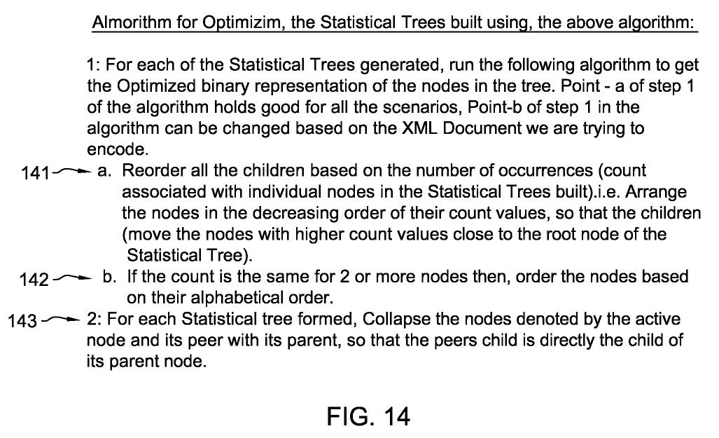

For each of the Statistical Trees generated, the following method, shown in the flowchart of FIG. 14, is run to get the Optimized binary representation of the nodes in the tree. Point-a of step 141 of the method holds good for many the scenarios, Point-b of step 142 in the method can be changed based on the XML Document being encoded.

Specifically, step 141 is to reorder the children based on the number of occurrences (count associated with individual nodes in the Statistical Trees built), i.e., arrange the nodes in the decreasing order of their count values, so that the children that occur more number of times would encode to a shorter binary code (move the nodes with higher count values close to the root node of the Statistical Tree). If the count is the same for two or more nodes, then, at step 142, the nodes are ordered based on their alphabetical order.

After this, at step 143, for each Statistical Tree formed, the nodes denoted by the active node and its peer are collapsed with its parent, so that the peer's child is directly the child of its parent node.

### Encoding and Decoding

Any suitable procedures may be used for Encoding and Decoding of the XML document. As the Statistical Trees are generated directly from the XML Document, and as the same Statistical Trees are needed to Decode the XML Document back, the generated Statistical Trees are, in this embodiment, possibly serialized with the XML Document encoded bits.

At the decoding end, the Statistical Trees are obtained by de-serializing the part of the e encode stream first and then use these Statistical Trees are used to Decode the XML Document back.

The Statistical Trees could also be compressed using any compression technology and then serialized with the encoded bits. At the decoding end, first we need to extract the Statistical part of the bit stream and run the corresponding decompression technique run on the encoding side to get back the Statistical Trees.

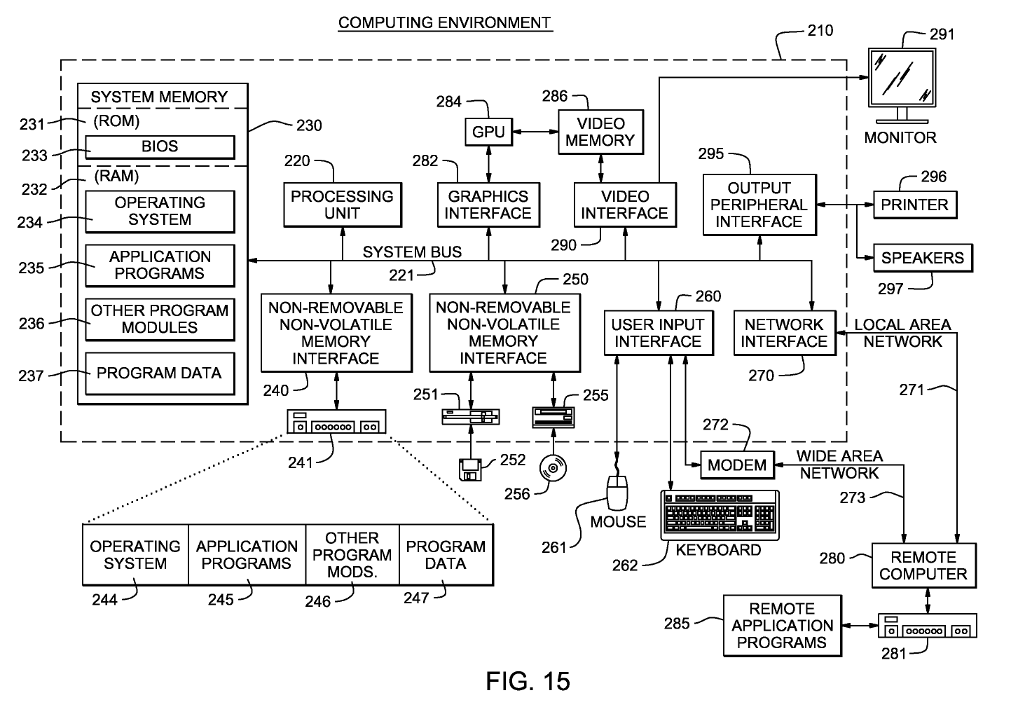

Embodiments of the invention may be generally implemented by a computer executing a sequence of program instructions for carrying out the steps of the method and may be embodied in a computer program product comprising media storing the program instructions. For example, FIG. 15 and the following discussion provide a brief general description of a suitable computing environment in which embodiments of the invention may be implemented. It should be understood, however, that handheld, portable, and other computing devices of all kinds are contemplated for use in connection with embodiments of the invention. While a general-purpose computer is described below, this is but one example, the embodiments of the invention may be implemented in an environment of networked hosted services in which very little or minimal client resources are implicated, e.g., a networked environment in which the client device serves merely as a browser or interface to the World Wide Web.

Although not required, embodiments of the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that embodiments of the invention may be practiced with other computer system configurations.

Other well known computing systems, environments, and/or configurations that may be suitable for use with embodiments of the invention include, but are not limited to, personal computers (PCs), server computers, hand-held or laptop devices, multi-processor systems, microprocessor-based systems, programmable consumer electronics, network PCs, minicomputers, mainframe computers, and the like. Embodiments of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 15, thus, illustrates an example of a suitable computing system environment 200 in which embodiments of the invention may be implemented, although as made clear above, the computing system environment 200 is only one example of a suitable computing environment and is not intended to suggest any limitation as to the scope or functionality. Neither should the computing environment 200 be interpreted as having any dependency or requirement relating to any one or combination of components illustrated in the exemplary operating environment 200.

With reference to FIG. 15, an example system for implementing embodiments of the invention includes a general purpose-computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 610.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 15 illustrates operating system 234, application programs 235, other program modules 236, and program data 237.

The computer 210 may also include other removable/non-removable, volatile/nonvolatile computer storage media. By way of example only, FIG. 15 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 15 provide storage of computer readable instructions, data structures, program modules and other data for the computer 210. In FIG. 15, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies.

A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interface and bus structures, such as a parallel port, game port or a universal serial bus (USB).

A monitor 291 or other type of display device is also connected to the system bus 221 via an interface, such as a video interface 290. A graphics interface 282, such as Northbridge, may also be connected to the system bus 221. Northbridge is a chipset that communicates with the CPU, or host-processing unit 220, and assumes responsibility for accelerated graphics port (AGP) communications. One or more graphics processing units (GPUs) 284 may communicate with graphics interface 282. In this regard, GPUs 284 generally include on-chip memory storage, such as register storage and GPUs 284 communicate with a video memory 286. GPUs 284, however, are but one example of a coprocessor and thus a variety of co-processing devices may be included in computer 210. A monitor 291 or other type of display device is also connected to the system bus 221 via an interface, such as a video interface 290, which may in turn communicate with video memory 286. In addition to monitor 291, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 15. The logical connections depicted in FIG. 15 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 15 illustrates remote application programs 285 as residing on memory device 281. It will be appreciated that the network connections shown are exemplary and other means of establishing a communications link between the computers may be used.

One of ordinary skill in the art can appreciate that a computer 210 or other client device can be deployed as part of a computer network. In this regard, embodiments of the invention pertain to any computer system having any number of memory or storage units, and any number of applications and processes occurring across any number of storage units or volumes. Embodiments of the invention may apply to an environment with server computers and client computers deployed in a network environment, having remote or local storage. Embodiments of the invention may also apply to a standalone computing device, having programming language functionality, interpretation and execution capabilities.

As will be readily apparent to those skilled in the art, embodiments of the invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks, could be utilized.

Embodiments may be embodied in a computer program product, which comprises the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

It will be appreciated that numerous modifications and embodiments may be devised by those skilled in the art, and it is intended that the appended claims cover all such modifications and embodiments as fall within the scope of the disclosure.

What is claimed is:

1. A method of compressing data from a markup language document, comprising:
creating from the document a path based statistical tree built according to a given set of rules; and
compressing said document by using said statistical tree.

2. The method according to claim 1, wherein said document is an XML document, the statistical tree includes a multitude of paths, and each of said paths is represented by a single bit.

3. The method according to claim 1, wherein the document includes enumerated data and non-enumerated data, and the compressing said document by using said statistical tree includes compressing said enumerated data by using said statistical tree.

4. The method according to claim 1, wherein the document includes a multitude of document nodes, and the creating from said document a path based statistical tree includes forming said tree with a multitude of tree nodes, each of the tree nodes representing one of the document nodes.

5. The method according to claim 4, wherein the forming the statistical tree includes:
identifying a root node of the document; and
creating the tree with a node denoting the root node of the document.

6. The method according to claim 5, wherein the forming the statistical tree further includes adding two children nodes to the root node of the tree, and designating one of the child nodes as active.

7. The method according to claim 6, wherein the forming the statistical tree further includes:
getting a text fragment from the document; and
checking the statistical tree to determine if the tree already has a node representing said fragment.

8. The method according to claim 7, wherein the forming the statistical tree further includes:
if the statistical tree already has a node representing said fragment, then incrementing a counter; and
if the statistical tree does not already have a node representing said fragment, then splitting a currently active node of the tree into two new nodes, and using one of said new nodes to represent said fragment.

9. The method according to claim 4, wherein the compressing the document by using said statistical tree includes:
optimizing the statistical tree to form an optimized statistical tree, by ordering the tree nodes according to a specified optimization rule; and
compressing the document by using the optimized statistical tree.

10. The method according to claim 9, wherein the ordering the tree nodes includes ordering the tree nodes based on the frequency of occurrence of the document nodes in the document.

11. A system for compressing data from a markup language document, comprising:
a statistical tree generator for processing the document and for building path based statistical tree from information read from the document and according to a given set of rules; and
a structural compressor for using said statistical tree to compress said document.

12. The system according to claim 11, further comprising a parser for parsing the document into text segments, and for feeding the text segments to the statistical tree generator and to the structural compressor.

13. The system according to claim 11, wherein said document is an XML document, the statistical tree includes a multitude of paths, and each of said paths is represented by a single bit.

14. The system according to claim 11, wherein the document includes a multitude of document nodes, and the path based statistical tree includes a multitude of tree nodes, each of the tree nodes representing one of the document nodes, and wherein the statistical tree generator identifies a root node of the document and creates the statistical tree with a node denoting the root node of the document.

15. The system according to claim 14, wherein:
the Statistical Tree generator includes an optimizer for optimizing the statistical tree to form an optimized statistical tree, by ordering the tree nodes according to a specified optimization rule; and
the structural compressor compresses the document by using the optimized statistical tree.

16. An article of manufacture comprising:
at least one computer usable medium having computer readable program code logic to execute a machine instruction in a processing unit for compressing data from a markup language document, the computer readable program code logic when executing performing the following steps:
creating from the document a path based statistical tree built according to a given set of rules; and
compressing said document by using said statistical tree.

17. The article of manufacture according to claim 16, wherein the document includes a multitude of document nodes, and the step of creating the path based statistical tree includes the step of forming said tree with a multitude of tree nodes, each of the tree nodes representing one of the document nodes.

18. The article of manufacture according to claim 17, wherein the step of forming the statistical tree includes the steps of:
identifying a root node of the document; and
creating the tree with a node denoting the root node of the document.

19. The article of manufacture according to claim 18, wherein the step of forming the statistical tree includes the further steps of:
getting a text fragment from the document;
checking the statistical tree to determine if the tree already has a node representing said fragment;
if the statistical tree already has a node representing said fragment, then incrementing a counter; and
if the statistical tree does not already have a node representing said fragment, then splitting a currently active node of the tree into two new nodes, and using one of said new nodes to represent said fragment.

20. The article of manufacture according to claim 16, wherein said document is an XML document, the statistical tree includes a multitude of paths, and each of said paths is represented by a single bit.
